(19) United States
(12) Patent Application Publication
(10) Pub. No.: US 2026/0063894 A1
(43) Pub. Date: Mar. 5, 2026

(54) LASER ADAPTER, MULTIPHOTON MICROSCOPE MAIN UNIT AND OPTICAL IMAGING SYSTEM

(71) Applicants: Peking University, Beijing (CN); Beijing Transcend Vivoscope Bio-Technology Co., Ltd., Beijing (CN)

(72) Inventors: Runlong WU, Beijing (CN); Jingquan TIAN, Beijing (CN); Ziyan YUN, Beijing (CN); Yanhui HU, Beijing (CN); Aimin WANG, Beijing (CN); Heping CHENG, Beijing (CN)

(73) Assignees: Peking University, Beijing (CN); Beijing Transcend Vivoscope Bio-Technology Co., Ltd., Beijing (CN)

(21) Appl. No.: 19/106,111

(22) PCT Filed: Dec. 21, 2023
(86) PCT No.: PCT/CN2023/140484

§ 371 Date: Feb. 24, 2025

(30) Foreign Application Priority Data
Nov. 2, 2022 (CN) 202211364119.8
Nov. 2, 2022 (CN) 202211364197.8
Nov. 2, 2022 (CN) 202211364226.0

(51) Int. Cl. G02B 27/00; G02B 21/00

(52) U.S. Cl. CPC G02B 27/0068; G02B 21/0032; G02B 21/0076

(57) ABSTRACT

Disclosed are a laser adapter, a multiphoton microscope main unit, an optical system. The laser adapter includes: a shell, and a beam transformation device and a beam stabilization device, which are arranged in the shell. The shell is provided with a laser input port and a laser output port. The beam transformation device is configured to transform a laser beam that enters the shell. The beam stabilization device is disposed downstream of the beam transformation device in a laser transmission direction, and is configured to adjust the laser transmission direction, so as to correct a deviation between an actual position and an ideal position of the laser beam at the laser output port. When lasers with different parameters are input or a laser deflects during transmission, there is no need to readjust an optical path or replace an optical device on the optical path.

### CROSS-REFERENCE TO RELATED APPLICATIONS

This application is a national stage of International Application No. PCT/CN2023/140484, filed on Dec. 21, 2023, which claims priority to Chinese Patent Application No. 202211364119.8, filed on Nov. 2, 2022, Chinese Patent Application No. 202211364197.8, filed on Nov. 2, 2022, and Chinese Patent Application No. 202211364226.0, filed on Nov. 2, 2022. All of the aforementioned applications are hereby incorporated by reference in their entireties.

### TECHNICAL FIELD

The present disclosure relates to the field of optical technologies, and in particular, to a laser adapter, a multiphoton microscope main unit, and an optical imaging system.

### BACKGROUND

In the existing laser coupling schemes, an adjustment mechanism with multiple degrees of freedom is usually used. A lens is set on the adjustment mechanism, and the spatial laser is coupled into the fiber by adjusting the lens. In order to ensure the coupling efficiency of the laser, it is usually necessary to select the lens according to the size of a spot outputted by the laser, the position of the beam waist, etc.

### SUMMARY

In view of this, the present disclosure provides a laser adapter, a multiphoton microscope main unit, and an optical system to solve problems of complex optical path adjustment and lens replacement in existing laser coupling schemes, as well as the decrease in laser coupling efficiency caused by easy changes in the laser.

According to an aspect of the present disclosure, a laser adapter is provided, and the laser adapter includes: a shell, and a beam transformation device and a beam stabilization device provided in the shell, where the shell includes a laser input port and a laser output port. The beam transformation device is configured to transform a laser beam entering the shell. The beam stabilization device is disposed downstream of the beam transformation device in a transmission direction of laser, and is configured to adjust the laser transmission direction to correct a deviation between an actual position and an ideal position of the laser beam at the laser output port.

According to another aspect of the present disclosure, a multiphoton microscope main unit is provided to solve problems of large space occupation, difficulty in handling and transferring, and complexity in installation and maintenance of multiphoton microscope main units in the prior art. The present disclosure provides a multiphoton microscope main unit configured to be connected with a microscope probe. The multiphoton microscope main unit includes an installation body. A wide field search module, a laser coupling module, a fluorescence collection module, and a scanning control module are integrated on the installation body. The wide field search module is configured to perform wide field imaging on a living object to search a target region, which is used for installing the microscope probe, of the living object. The laser coupling module is configured to receive the laser beam, and adjust the laser beam to couple the laser into a laser transmission fiber. The laser transmission fiber is configured to connect the laser coupling module with the microscope probe. The scanning control module is connected with the microscope probe through a control cable, and is configured to control the microscope probe to perform laser scanning to generate fluorescence signal. The fluorescence collection module is connected to the microscope probe through a fluorescence collection fiber, and is configured to collect the fluorescence signal output from the microscope probe.

According to still another aspect of the present disclosure, an optical imaging system is provided to solve problems of optical imaging systems in the prior art. For example, the optical path needs to re-adjust based on changes in the laser emitted by the laser device, and poor flexibility in use. The present disclosure provides an optical system, and the optical system includes a laser device, a transmission fiber, a main unit of application apparatus, and the laser adapter as described above. The laser device is disposed at the laser input port of the laser adapter for emitting laser to the laser input port. One end of the transmission fiber is connected to a laser coupler, the laser coupler is connected to the laser output port of the laser adapter, and the other end of the transmission fiber is connected to the main unit of application apparatus.

According to yet another aspect of the present disclosure, an optical system is provided. And the optical system includes a laser device, a laser adapter, and a microscope host, where the laser device is configured to emit the laser beam to the laser adapter; the laser adapter is configured to receive the laser emitted by the laser device, adjust and adapt the laser beam, and transmitting the laser adjusted and adapted to the microscope host; and the microscope host is configured to transmit the laser beam to a microscope probe, and controlling the microscope probe to perform laser scanning on a living object to generate fluorescence signal used for imaging.

In the technical solution provided in the present disclosure, the laser adapter is provided with a beam transformation device and a beam stabilization device. The beam transformation device may perform beam transformation on the input laser, enabling the laser to match with an apparatus connected therebehind and achieve the best performance of the device. The beam stabilization device may adjust deflection direction of the laser when detecting a deviation of the laser beam, ensuring stability of laser output and thus ensuring the coupling efficiency of laser output. Therefore, by using the laser adapter provided in the present disclosure, when lasers with different parameters are input or a laser deflects during transmission, there is no need to readjust an optical path or replace an optical device on the optical path. By means of the transformation of the input laser and the adjustment of the laser transmission direction by the laser adapter, the laser can be adapted and coupled to an apparatus connected therebehind.

The multiphoton microscope main unit integrates various functional modules into a unified structure, which greatly reduces space occupation and is suitable for various laboratories. Moreover, the overall setting can make the output line neat, tidy, and beautiful. In addition, the multiphoton microscope main unit is easy to move and transfer due to a small size and portability. Meanwhile, the multiphoton microscope main unit is convenient to match more applications due to the quick adjustment of the position and orientation of the multiphoton microscope main unit for certain experimental needs. In addition, the multiphoton microscope main unit is easy to install and maintain on site quickly.

In the optical system provided in the present disclosure, the laser generated by the laser device passes through the laser adapter, which can amplify, shrink, and zoom the laser beam, convert various laser signals received into a unified laser signal output, so that the laser is adapted to an apparatus connected therebehind to achieve the best performance of the system. Thus, lasers with different parameters can be used, or even if the distance of the laser changes, the received laser can be transformed and processed through the laser adapter to output an adapted laser beam to the microscope host.

Other features and advantages of the present disclosure will be explained in detail in the subsequent detailed descriptions of the embodiments section.

### BRIEF DESCRIPTION OF THE DRAWINGS

The drawings form a part of the present disclosure and are used to provide further understanding of the present disclosure. The illustrative embodiments and their descriptions in the present disclosure are used to explain the present disclosure and do not constitute improper limitations to the present disclosure.

FIG. 1 is a schematic diagram of the appearance of a laser adapter according to an embodiment of the present disclosure.

FIG. 2 is a schematic structural diagram of a laser adapter without an upper cover according to an embodiment of the present disclosure.

FIG. 3 is a schematic structural diagram of an optical system according to an embodiment of the present disclosure.

FIG. 4 is a schematic diagram of an optical path of an optical system according to an embodiment of the present disclosure.

FIG. 5 is a schematic diagram of an appearance structure of a multiphoton microscope main unit according to an embodiment of the present disclosure.

FIG. 6 is a schematic structural diagram of a shading door in an open state of the multiphoton microscope main unit shown in FIG. 5.

FIG. 7 is a schematic structural diagram of a multiphoton microscope main unit in a decomposed state according to an embodiment of the present disclosure.

FIG. 8 is a schematic structural diagram of a multiphoton microscope main unit in a decomposed state in another perspective.

FIG. 9 is a schematic installation diagram of a move module, a living object installation device, and a view search adapter according to an embodiment of the present disclosure.

FIG. 10 is a schematic structural diagram of a living object installation device according to an embodiment of the present disclosure.

FIG. 11 is a schematic structural diagram of a laser coupling module according to an embodiment of the present disclosure.

FIG. 12 is a schematic diagram of an internal structure of the laser coupling module shown in FIG. 11.

FIG. 13 a schematic structural diagram of a laser coupling module with a wide field search module installed according to an embodiment of the present disclosure.

FIG. 14 is a schematic structural diagram of a control box according to an embodiment of the present disclosure.

FIG. 15 is a front view of the control box shown in FIG. 14.

FIG. 16 is a schematic structural diagram of a storage device according to an embodiment of the present disclosure.

FIG. 17 is a schematic structural diagram of a storage device in a decomposed state according to an embodiment of the present disclosure.

FIG. 18 is a schematic structural diagram of an optical system according to an embodiment of the present disclosure.

FIG. 19 is a schematic structural diagram of an optical system according to another embodiment of the present disclosure.

### DETAILED DESCRIPTION OF THE EMBODIMENTS

A clear and complete description of the technical solutions in the embodiments of the present disclosure will be given with reference to the drawings. Obviously, the described embodiments are only a part of the embodiments of the present disclosure, and not all of them. Based on the embodiments of the present disclosure, all other embodiments obtained by those skilled in the art without creative efforts fall within the protection scope of the present disclosure. Under the condition of no conflict, the implementation modes and features in the present disclosure can be combined with each other.

In the description of the present disclosure, it should be understood that the terms “center”, “longitudinal”, “lateral”, “upper”, “lower”, “left”, “right”, “vertical”, “horizontal”, “top”, “bottom”, “axial”, “radial”, “circumferential” and so on indicate the direction or positional relationship based on the direction or positional relationship shown in the drawings, which are only for the convenience of describing the present disclosure and simplifying the description, and do not indicate or imply that the indicated device or component must have a specific direction or be constructed and operated in a specific direction. Therefore, they cannot be considered as limitations to the present disclosure. In addition, the terms “inner” and “outer” refer to the inside and outside relative to the contour of each component.

Furthermore, the terms “first” and “second” are used for descriptive purposes only and do not indicate or imply relative importance or implicitly indicate the number of indicated technical features. Therefore, features limited by “first” and “second” can explicitly or implicitly include at least one of the features.

In the conventional laser coupling schemes, if the laser is replaced or the spot size needs to be changed, it is necessary to readjust the optical path or select a new lens. The adjustment of the optical path and lens replacement are complex and require professional operation.

In addition, if the environment changes, such as vibrations or temperature fluctuations, the output pointing angle of the laser device will also change. Typically, laser devices have a pointing angle change of 25 μrad/° C., which means that if the temperature changes by 10° C., the pointing angle will change by 250 μrad. This change in laser pointing will cause a sharp decline in the fiber coupling efficiency, greatly affecting the performance of the equipment. Moreover, in the case of beam deflection caused by human error or accidental touch, the system also needs to be re-adjusted.

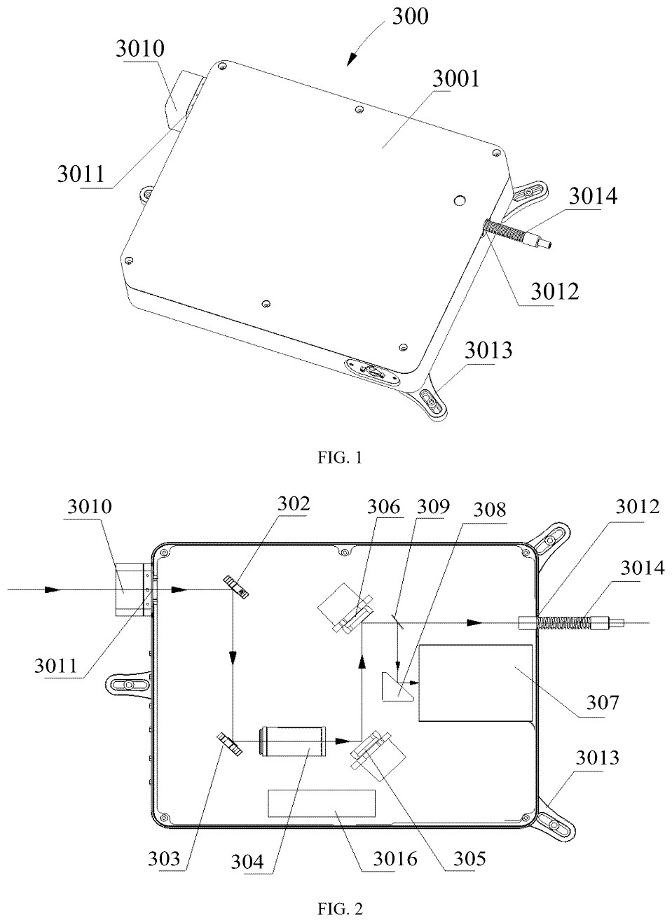

The present disclosure provides a laser adapter, as shown in FIGS. 1 to 2, the laser adapter 300 includes: a shell 3001, and a beam transformation device 304 and a beam stabilization device provided in the shell 3001. The shell 3001 includes a laser input port 3011 and a laser output port 3012. The beam transformation device 304 is configured to transform a laser beam entering the shell 3001. The beam stabilization device is disposed downstream of the beam transformation device 304 in a laser transmission direction, and is configured to adjust the laser transmission direction to correct a deviation between an actual position and an ideal position of the laser beam at the laser output port 3012.

The laser adapter provided in the present disclosure may perform beam transformation on the input laser through the beam transformation device 304. The beam transformation includes amplification, reduction, and zooming of a beam according to transformation characteristics of optical components, enabling the laser to match with an apparatus connected therebehind and achieve the best performance of the device. And the laser adapter provided in the present disclosure may adjust deflection direction of the laser when detecting a deviation of the laser beam through the beam stabilization device, ensuring stability of laser output and thus ensuring the coupling efficiency of laser output.

Specifically, when lasers with different parameters emitted by laser devices with different parameters enter the laser adapter, the beam transformation device 304 may uniformly output a beam with a fixed spot size after the beam transformation, so that the laser output from different laser devices can be adapted to an apparatus connected therebehind. Alternatively, if a distance of the laser device changes, a unified laser beam can also be output after zooming through the beam transformation device 304.

When the environment changes (such as changes in temperature, humidity, and so on, or vibration), components on the optical path (such as the laser device itself, reflectors, spectroscopes, and so on) may experience vibration or displacement affected by temperature, resulting in changes in the output direction of the laser. The beam stabilization device may adjust the deflection direction of laser in real time based on the deviation between an actual position and an ideal position of the laser beam at the laser output port 3012, enabling stability of the laser output, that is, controlling the laser to output within a small deviation range from the ideal output position, and ensuring the coupling efficiency of laser output.

Therefore, by using the laser adapter provided in the present disclosure, when lasers with different parameters are input or a laser deflects during transmission, there is no need to readjust an optical path or replace an optical device on the optical path. Simply by means of the transformation of the input laser and the adjustment of the laser transmission direction by the laser adapter, the laser can be adapted and coupled to an apparatus connected therebehind.

In an embodiment, the beam transformation device 304 may adopt existing devices that can expand or reduce the cross-section of the laser beam, and zoom the laser beam. The specific structure of the device is achievable by those skilled in the art, and will not be described herein.

The beam stabilization device is disposed downstream of the beam transformation device 304 in a laser transmission direction. In this way, the beam stabilization device may correct the beam deflection caused by the adjustment, such as amplification, reduction, or zooming through the beam transformation device 304.

As shown in FIG. 2, the beam stabilization device may include a position detector 307, at least one deflection mirror, and a mirror adjustment mechanism connected to a respective deflection mirror. The position detector 307 is disposed near the laser output port 3012, and is configured to detect position information of the laser beam at the laser output port 3012. Specifically, a spectroscope 309 may be disposed on the laser transmission path to directly or indirectly reflect a part of the laser to the position detector 307, thereby achieving the laser position detection by the position detector 307. In an embodiment shown in FIG. 2, the spectroscope 309 reflects a part of the laser beam to a laser power meter 308, and the laser power meter 308 is also provided with a spectroscope. The laser power meter reflects a part of the laser to the position detector 307. The position detector 307 may be a 4D position detector, which can strictly detect and distinguish position drift and angle drift of the beam, and accurately detect a real-time position of the beam.

The mirror adjustment mechanism is configured to drive the deflection mirror to adjust the laser transmission direction based on the position information detected by the position detector 307, enabling the stability of the laser output.

Specifically, firstly, an ideal position of the laser beam at the laser output port 3012 is determined. The ideal position is a position where the laser may achieve a desired coupling efficiency when output and coupled to a device or a component (such as, a transmission fiber) connected to the laser output port 3012. When the beam deflects, for example, due to deviation of optical components caused by vibration or temperature changes, or human touch, the position detector 307 detects the position information of the laser beam at the laser output port 3012 in real time and sends it to a control unit. The control unit continuously determines the deviation between the position of the laser beam and the ideal position based on the position information, and controls the mirror adjustment mechanism to adjust the deflection mirror, thereby continuously adjusting a laser reflection direction and ensuring stable transmission of the laser within a certain range around the ideal position.

The laser adapter may further include a control unit. The control unit is configured to receive position information detected by the position detector 307 and control the mirror adjustment mechanism based on the position information. In some implementation, the control unit may be arranged inside the shell 3001, and of course, the control unit may also be arranged separately, that is, the control unit may be a separate module disposed outside the shell 3001.

As shown in FIG. 2, the shell 3001 of the laser adapter is further provided with a driving circuit 3016. After the control unit sends a control signal to the driving circuit 3016, the mirror adjustment mechanism is controlled to operate by the driving circuit 3016.

In an embodiment, the laser adapter 300 may further include at least one fixed mirror used for changing the laser transmission direction, and the fixed mirror is disposed upstream of the beam transformation device 304 in the laser transmission direction. The fixed mirror is provided to change the laser transmission direction, so that the optical path may be bent, thereby making it easier to arrange various components on the optical path and reducing a volume of the entire laser adapter.

In the embodiment shown in FIG. 2, the at least one fixed mirror includes a first fixed mirror 302 and a second fixed mirror 303, and the at least one deflection mirror includes a first deflection mirror 305 and a second deflection mirror 306.

The laser is reflected by the first fixed mirror 302 to the second fixed mirror 303, and then reflected by the second fixed mirror 303 to the beam transformation device 304. After the beam transformation device 304 performs transformation on the laser, and the laser emitted is reflected by the first deflection mirror 305 to the second deflection mirror 306. The second deflection mirror 306 is configured to reflect the laser to the laser output port 3012.

More specifically, an incidence angle and an exit angle of the laser at the first fixed mirror 302 and at the second fixed mirror 303 are approximately 45 degrees, respectively. An incidence angle and an exit angle of the laser at the first deflection mirror 305 and at the second deflection mirror 303 are approximately 45 degrees, respectively.

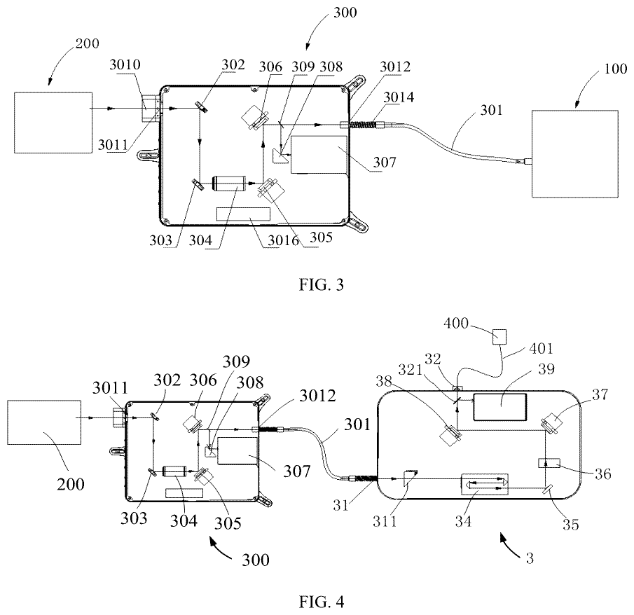

Referring to FIG. 3, a laser transmission path is shown in FIG. 3. The laser emitted by the laser device 200 enters from the laser input port 3011 and transmits to the first fixed mirror 302. The first fixed mirror 302 deviates the laser by about 90 degrees, and reflects the laser to the second fixed mirror 303. The second fixed mirror 303 deviates the laser by about 90 degrees, and reflects the laser to the beam transformation device 304. The beam transformation device 304 performs beam transformation on the laser and transmits the laser to the first deflection mirror 305. The first deflection mirror 305 deviates the laser by about 90 degrees, and reflects the laser to the second deflection mirror 306. The second deflection mirror 306 reflects the laser to the laser output port 3012, and the laser is coupled into a component connected to the laser output port 3012. For example, the laser output port 3012 is connected to a laser coupler 3014 through a transmission fiber 301.

In this embodiment, the optical path is bent through the fixed mirrors and the deflection mirrors, thereby reducing a length of the laser adapter and facilitating the arrangement of various optical components.

The arrangement of the fixed mirrors and the deflection mirrors is not limited to the description mentioned above, and other arrangements may also be used.

In an embodiment, at least one laser power meter 308 is provided in the shell 3001 for detecting the power of the laser entering the laser adapter. The laser power meter 308 is capable of detecting power change of laser in real time. Thus, it can be determined whether there is a problem with laser transmission, especially whether there is a problem with an input end of the laser, such as whether the laser device is damaged or whether the laser is obstructed.

Optionally, the laser power meter 308 is located near the laser output port 3012 and is configured to detect the power of the laser output from the laser adapter.

As shown in FIG. 3, a spectroscope 309 is disposed on the laser transmission path. Through the spectroscope 309, a part of the laser beam is reflected back to the laser power meter 308, and the laser power meter 308 may obtain the laser power by detecting the beam split.

Optionally, the at least one laser power meter includes a first laser power meter and a second laser power meter. The first laser power meter may be disposed near the laser input port 3011, and the second laser power meter may be disposed near the laser output port 3012. That is, the first laser power meter is configured to detect the power of the laser input, and the second laser power meter is configured to detect the power of the laser output. By detecting a change in laser power during laser input, it may be determined whether there is a problem with the laser input, such as whether the laser device is damaged or blocked. By using the first laser power meter and the second laser power meter to detect the power of the laser input and output respectively, a change during laser output and laser input may be determined, thereby determining a power loss of the laser in the laser adapter.

In an embodiment, the laser adapter 300 further includes a switch device 3010 disposed at the laser input port 3011, the switch device 3010 includes a switch door used for opening and closing the laser input port 3011, and a door driving mechanism for driving the switch door to switch between an open state and a closed state.

When the switch door is open, the laser enters the laser adapter 300 for transmission, and when the door is closed, the laser is blocked from entering the laser adapter.

The door driving mechanism may be controlled by a control unit. The control unit may send a control signal, and a driving circuit 3016 may control the door driving mechanism to drive the switch door to open or close.

In addition, support legs 3013 may be disposed below the shell 3001 of the laser adapter 300, and lengths of the support legs are adjustable. By adjusting the lengths of the support legs 3013, a height of the laser input port 3011 may be adapted to a height of the laser device, thereby allowing the laser to accurately emit laser to the laser input port 3011.

The adjustable support legs 3013 may be realized by adopting existing common techniques, such as adjusting bolts adopted for adjusting the lengths of the support legs 3013, or setting the support leg 3013 to include two parts, which are connected at different height positions to adjust the height.

Another embodiment of the present disclosure further provides an optical system. One of the most direct and effective methods for studying a relationship between animal behavior and neural function is to directly record neuronal activity in living animals with free movement. A multi-photon optical imaging system, with its excellent optical slicing ability and deep penetration depth, has become the most important and widely used tool for observing neurons. The multi-photon optical imaging system may include nonlinear laser scanning microscope devices such as two-photon, three-photon, Raman, and so on.

In the existing multi-photon optical imaging system, a laser device and an optical adjusting frame are fixed on an optical platform to adjust the optical path. After the optical path is shaped, the optical path enters a microscope host through a mirror. Since the optical path from the laser device to the microscope host is a spatial optical path, the microscope host must also be stably fixed on the optical platform to ensure that the internal optical path of the host is not deflected by external forces and affects the performance of the microscope.

However, due to the placement of many other modules in the surrounding area, such as a beam shaping module, a circuit control module, various drivers, a fluorescence collection module, a wide field fluorescence module, a laser module and the like, the device and the wiring are complex, and the modules are susceptible to signal interference and human error in operation, resulting in deviation on the optical path.

In addition, as the optical path and the microscope host are fixed, experiments that require a specific position and direction of the microscope body may not be changed or implemented. For example, an optical path of a laser and a microscope body may not be arranged on a same platform, or even in a same room, which cannot be achieved through traditional methods. If a laser device needs to be replaced, or if a distance of the laser device changes, all optical paths need to be re-adjusted due to changes in the laser emitted by the laser device, and some may even be unable to be adapted due to significant differences in laser parameters.

The present disclosure provided an optical system, as shown in FIG. 3, the optical system includes a laser device 200, a transmission fiber 301, a main unit of application apparatus 100, and a laser adapter 300 mentioned in the above embodiments. The main unit of application apparatus 100 may be a device or a microscope host that works through laser, such as a two-photon microscope. The laser device 200 is configured to emit laser to the laser adapter 300. The laser adapter 300 is configured to receive the laser emitted by the laser device 200, adjust and adapt the laser, and transmit the laser adjusted and adapted to the main unit of application apparatus 100. The main unit of application apparatus 100 is configured to transmit the laser to a microscope probe, and control the microscope probe to perform laser scanning on a living object to generate a fluorescence signal used for imaging.

According to the technical solution provided in the present disclosure, the laser generated by the laser device 200 passes through the laser adapter 300, and then the laser adapter 300 is configured to amplify, shrink, and zoom the laser beam, and convert the laser signals received into a unified laser signal output, so that the laser is adapted to an apparatus connected therebehind to achieve the best performance of the system. Thus, lasers with different parameters may be used, and even if the distance of the laser device changes, the received laser may be transformed and processed through the laser adapter 300 to output an adapted laser beam to the main unit of application apparatus 100.

As shown in FIG. 4, the optical system may further include a microscope probe 400, and the main unit of application apparatus 100 may be a multiphoton microscope main unit.

The laser device 200 is disposed at the laser input port 3011 of the laser adapter 300, and is configured to emit laser to the laser input port 3011. One end of the transmission fiber 301 is connected to a laser coupler 3014, and the laser coupler 3014 is connected to the laser output port 3012. The other end of the transmission fiber 301 is connected to the main unit of application apparatus 100.

The laser is stably coupled to the transmission fiber 301 through the laser adapter 300, and then transmitted to the main unit of application apparatus 100 through the transmission fiber 301. Laser with different parameters emitted by the laser device 200 can be adjusted to adapt to the main unit of application apparatus, ensuring that the main unit of application apparatus is not affected by changes in the parameters of the laser device 200 or the distance between the laser device 200 and the laser adapter 300. Therefore, there is no need to replace optical components on the optical path or adjust the entire optical path, making it more convenient to use.

Specifically, the laser device 200 is used for emitting laser to the laser adapter 300, the laser adapter 300 is configured to receive the laser emitted by the laser 200, adjust and adapt the laser, and then transmit the adjusted and adapted laser to the main unit of application apparatus 100. The main unit of application apparatus 100 is configured to transmit the laser to the microscope probe 400, and control the microscope probe 400 to perform laser scanning on a living object to generate fluorescence signal used for imaging.

According to the technical solution provided in the present disclosure, the laser generated by the laser device 200 passes through the laser adapter 300, which is capable of amplifying, shrinking, and zooming the laser beam, to convert the laser signals received into a unified laser signal output, so that the laser is adapted to an apparatus connected therebehind to achieve the best performance of the system. Thus, lasers with different parameters may be used, and even if the distance of the laser device changes, the received laser can be transformed and processed through the laser adapter 300 to output an adapted laser beam to the main unit of application apparatus 100.

The optical system provided by the present disclosure is a multi-photon imaging system, which means that the microscope probe 400 may be a nonlinear laser scanning microscope device such as two-photon, three-photon, Raman, and so on. In some embodiments, the microscope probe 400 may specifically include a Micro-Electro-Mechanical System (MEMS), a scanning galvanometer and various lenses.

In an embodiment, the optical system may further include a transmission fiber 301 connected between the laser adapter 300 and the main unit of application apparatus 100. The laser adapter 300 transmits the laser adjusted and adapted to the main unit of application apparatus 100 through the transmission fiber 301. One end of the transmission fiber 301 may be connected to a laser coupler 3014, and further connected to the laser output port of the laser adapter 300 through the laser coupler 3014, and the other end is connected to a collimator, and further connected to the main unit of application apparatus 100 through the collimator.

The laser adapter 300 is connected to the main unit of application apparatus 100 through fiber optic connection, so that the main unit of application apparatus 100 may be moved freely. Therefore, the main unit of application apparatus 100 may be placed in different positions or even cross platforms as needed, making it more flexible to use.

Moreover, the optical fibers may play a role in shaping for beam output, so that a spot output from the laser adapter 300 to the main unit of application apparatus 100 may be more uniform, which is conducive to improving the performance of the system. In addition, compared to a method of providing a fixed optical path adjusting device between the laser adapter 300 and the main unit of application apparatus 100, the fiber optic connection method may reduce interference and incorrect operation, improve system stability, and reduce arrangement of the optical path adjusting device before modules, making installation and maintenance easy.

In an embodiment, the main unit of application apparatus 100 includes a laser coupling module 3. A laser input end 31 of the laser coupling module 3 is connected to the transmission fiber 301, and a laser output end 32 is connected to the microscope probe 400 through the laser transmission fiber 401.

The laser coupling module 3 is configured to adjust the laser received from the transmission fiber 301 and transmit the adjusted laser to the microscope probe 400 through the laser transmission fiber 401. For example, the laser coupling module 3 may perform dispersion compensation and/or intensity adjustment on the laser.

FIG. 4 is a schematic diagram of an optical path of an optical system according to an embodiment of the present disclosure. As shown in FIG. 4, the laser adapter 300 includes a laser power meter 308 for detecting laser power, and the laser coupling module 3 includes a power detector 311 for detecting laser power.

The laser power meter 308 may detect the laser power entering the laser adapter 300 in real time, to determine whether there is an issue arising during laser transmission through the power change detected by the laser power meter 308. For example, whether the laser device 200 is damaged or whether the laser is obstructed may be determined. Specifically, a first spectroscope 309 may be disposed on the laser transmission path, and a part of the laser beam is split by the first spectroscope 309 to the laser power meter 308. The laser power is obtained by detecting the split beam through the laser power meter 308. The power detector 311 may detect the laser power entering the laser coupling module 3 in real time. Similarly, by splitting the laser beam, the laser power of the laser entering the laser coupling module 3 is obtained by detecting the split beam through the power detector 311. By comparing a power change between the power detector 311 and the laser power meter 308, it can be determined whether the laser transmission between the laser adapter 300 and the main unit of application apparatus 100 is abnormal. Therefore, by providing the laser power meter 308 and the power detector 311, issues arising during the laser transmission may be quickly located.

Optionally, the laser power meter 308 is located near the laser output port 3012 of the laser adapter 300, and the power detector 311 is located near the laser input end 31 of the laser coupling module 3. If the power detected by the power detector 311 changes significantly compared to the power detected by the laser power meter 308, it can be determined that there is a problem with the laser power meter 308. Thus, the problem can be quickly located and quickly repaired.

A laser transmission path is described as follows with reference to FIG. 4.

A laser emitted by the laser device 200 enters through the laser input port 3011 and then the laser is transmitted to a first fixed mirror 302. The laser is deflected by the first fixed mirror 302 by 90 degrees approximately, and reflected to the second fixed mirror 303. Then the laser is deflected by the second fixed mirror 303 by 90 degrees approximately, and reflected to the beam transformation device 304. The beam transformation device 304 performs beam transformation on the laser and transmits the laser to the first deflection mirror 305. The laser is deflected by the first deflection mirror 305 by 90 degrees approximately, and reflected to the second deflection mirror 306. The laser is reflected by the second deflection mirror 306 to the laser output port 3012, and coupled into the transmission fiber 301 connected to the laser output port 3012.

The laser transmitted by the transmission fiber 301 enters the laser coupling module 3 from a laser input end 31. A dispersion compensation member 34 performs dispersion compensation on the laser and transmits the laser to a mirror 35. The laser is deflected by the mirror 35 by 90 degrees approximately, and transmitted to an acousto-optic modulator 36. The acousto-optic modulator 36 adjusts the intensity of the laser, and transmits the laser to a third deflection mirror 37. The laser is deflected by the third deflection mirror 37 by 90 degrees approximately, and reflected to a fourth deflection mirror 38. The laser is reflected by the fourth deflection mirror 38 to a laser output end 32. Finally, the laser is coupled into the laser transmission fiber 401 connected to the laser output end 32.

The optical system provided in the present disclosure may further include a workbench. The workbench may include a workbench host and a monitor. The workbench host is connected to the main unit of application apparatus 100. The main unit of application apparatus 100 is configured to process the collected a fluorescence signal and transmit the fluorescence signal to the workbench host. Then, the monitor is configured to display an image. The workbench host may further send a control command to the main unit of application apparatus 100, and each component of the main unit of application apparatus 100 may be controlled by control circuits in a control box.

The optical system provided by the present disclosure may further include a behavioral experimental device. The behavioral experimental device provides activity space for a living object equipped with the microscope probe 400. For example, a mouse equipped with the microscope probe 400 may be placed into the behavioral experimental device, allowing it to move freely to detect the state of its neurons during free movement.

According to another aspect, an embodiment of the present disclosure provides a main unit of application apparatus. One of the most direct and effective methods for studying the relationship between animal behavior and neural function is to directly record the neuronal activity in living animals with free movement. A multiphoton microscope device has become the most important and widely used tool for observing animal neurons through fluorescence imaging. The multiphoton microscope device may include a nonlinear laser scanning microscope device, such as two-photon, three-photon, Raman, and so on.

Currently, the multiphoton microscope device has problems of complex structure, large volume, large space occupation, complex connections, difficulty in handling and transferring, and complexity in installation and later maintenance.

The main unit of application apparatus provided by an embodiment of the present disclosure is a multiphoton microscope main unit 100, which is connected with a microscope probe. The microscope probe is detachably installed on a living object to observe neuronal activity in the living object.

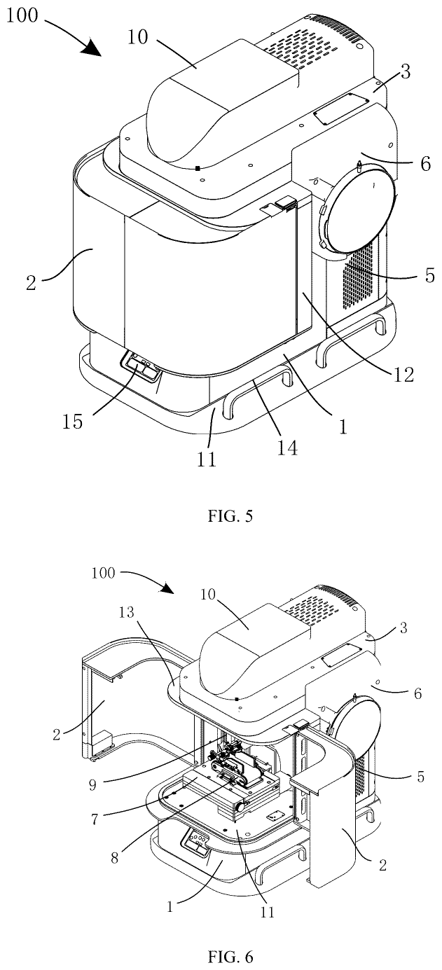

As shown in FIGS. 5 to 8, the multiphoton microscope main unit 100 provided by the embodiment of the present disclosure includes an installation body 1, and a wide field search module 4, a laser coupling module 3, a fluorescence collection module, and a scanning control module, which are integrated on the installation body 1. The wide field search module 4 is configured to perform wide field imaging on a living object to search a target region of the living object, which is used for installing the microscope probe. The laser coupling module 3 is configured to receive laser, and adjust the laser to couple the laser into a laser transmission fiber. The laser transmission fiber is configured to connect the laser coupling module 3 with the microscope probe. The scanning control module is connected to the microscope probe through a control cable, and is configured to control the microscope probe to perform laser scanning to generate a fluorescence signal. The fluorescence collection module is connected to the microscope probe through a fluorescence collection fiber, and is configured to collect the fluorescence signal output from the microscope probe.

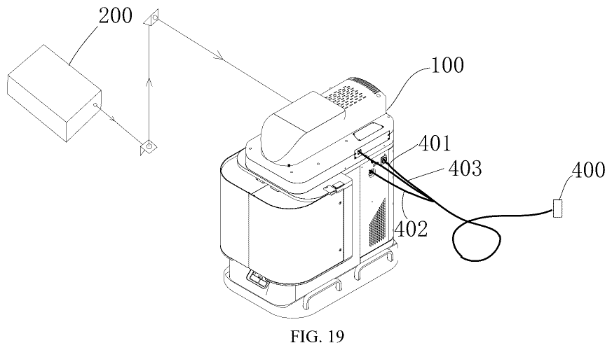

During application, the multiphoton microscope main unit 100 is connected to the microscope probe 400, as shown in FIGS. 18 and 19. The laser coupling module 3 of the multiphoton microscope main unit 100 is connected to the microscope probe 400 through the laser transmission fiber 401, the scanning control module is connected to the microscope probe 400 through the control cable 403, the fluorescence collection module is connected to the microscope probe 400 through the fluorescence collection fiber 402, and the microscope probe 400 is configured to be worn on a living object. When the laser coupling module 3 receives the laser and transmits it to the microscope probe 400 through the laser transmission fiber 401, the scanning control module controls the microscope probe 400 to perform laser scanning on the living object through the control cable 403 to generate a fluorescence signal. Then the fluorescence collection module collects the fluorescence signal output from the microscope probe 400 through the fluorescence collection fiber 402. The fluorescence signal output can be converted into an electrical signal and imaged on the computer. Then, the neuronal activity of the living object can be observed through imaging.

The microscope probe 400 may include a Micro-Electro-Mechanical System (MEMS) scanning galvanometer and various lenses. Therefore, the scanning control module may include a MEMS control module that controls the MEMS scanning galvanometer.

According to the multiphoton microscope main unit provided by the present disclosure, various functional modules are integrated into a unified structure, greatly reducing space occupation and being suitable for various laboratories. Moreover, the overall setting can make the output line neat, tidy, and beautiful. In addition, the multiphoton microscope main unit is easy to move and transfer due to a small size and portability; and the multiphoton microscope main unit is convenient to match more applications due to quick adjustment of the position and orientation of the multiphoton microscope main unit for certain experimental needs. In addition, the multiphoton microscope main unit is easy to install and maintain on site quickly. The multiphoton microscope device in the present disclosure may include a nonlinear laser scanning microscope device such as two-photon, three-photon, Raman, and so on.

In an embodiment, the multiphoton microscope main unit 100 may further include a move module 7 provided on the installation body 1, which is configured to load a living object and drive the living object to move in a plurality of directions. The wide field search module 4 is configured to perform a wide field search on the living object fixed on the move module 7.

Specifically, the living object may be directly installed on the move module 7. More specifically, the living object may be restricted by providing a clamping structure or a limiting structure on the move module 7. Alternatively, the living object may also be fixed on a living object installation device 8, and then the living object installation device 8 may be installed on the move module 7. The move module 7 may move with the living object installation device 8 to adjust the position of the living object. Therefore, different regions of the living object may be imaged by the wide field search module 4 to search for a target position of interest. The move module 7 may be a multi-axis mobile platform that is capable of moving in a plurality of directions including up, down, left, right, front, and back.

The wide field search module 4 is a device capable of performing large view imaging on the living object. A single-photon fluorescence imaging device may be adopted as the wide field search module 4. The imaging of the wide field search module 4 may be transmitted to the computer for display. Alternatively, an eyepiece may be disposed on the wide field search module 4, so that the imaging may be observed directly through the eyepiece.

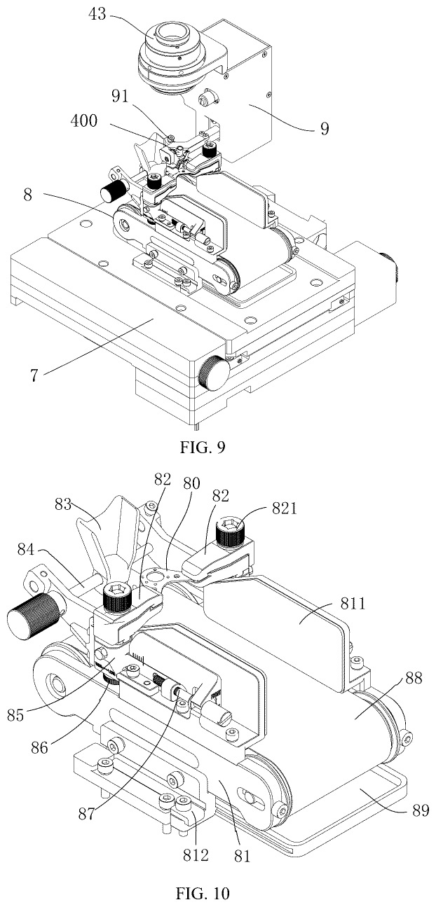

In an embodiment shown in FIG. 9, when the wide field search module 4 is used to perform wide field imaging on the living object, the living object is installed on the living object installation device 8, and the living object installation device 8 is installed on the move module 7. Therein, the living object may be a mouse or other animal.

FIG. 10 provides a living object installation device 8 suitable for installing a mouse (not ruled out for installing other suitable animals), including: a mounting base 81, and a treadmill 88 and a clamping mechanism, which are provided on the mounting base 81. The clamping mechanism may include two opposite clamping components 82 for clamping both sides of a probe mounting component 80 disposed on the mouse (the probe mounting component 80 is usually installed on the head of the mouse, FIG. 10 only shows the probe mounting component 80 without the mouse). When the clamping mechanism clamps and fixes the probe mounting component 80, the mouse can run on the treadmill 88. The mounting base 81 is equipped with baffles 811 located on both sides of the treadmill 88, and the baffles 811 are used for confining the mouse on the treadmill 88. And the mounting base 81 is further equipped with a fixing bracket 812 for fixing on the move module 7, which can be fixed by bolts.

When the probe mounting component 80 disposed on the mouse is clamped by the clamping component 82, the mouse runs on the treadmill 88, which may distract attention of the mouse, reduce stress response of the conscious mouse during the installation process, and facilitate rapid experimentation.

Optionally, each clamping component 82 may include two clamping portions and a first adjusting bolt 821. The first adjusting bolt 821 is configured to make the two clamping portions closer to each other to clamp the probe mounting component 80, or far away from each other to release the probe mounting component 80 through rotation. Therefore, it is easy to assemble and disassemble by simply rotating the first adjusting bolt 821 of the two clamping components 82 during clamping or disassembling the probe mounting component 80.

Optionally, the two clamping components 82 are configured to be able to move in forward and backward directions of the treadmill 88 relative to the mounting base 81, and to move up and down relative to the mounting base 81. Thus, the clamping components 82 can be adjusted to be in an appropriate position to clamp the probe mounting component 80 based on a type or a size of the living object.

Specifically, the living object installation device 8 may further include a mobile frame 85 corresponding to each clamping component 82. The mobile frame 85 is configured to be able to move in the forward and backward directions of the treadmill 88 relative to the mounting base 81, and the clamping component 82 is adjustably disposed on the mobile frame 85. As shown in FIG. 10, a second adjustment bolt 86 is provided on the mobile frame 85 for adjusting the clamping component 82 for lifting and lowering. By rotating the second adjustment bolt 86, the clamping component 82 may be lifted; and by rotating the second adjustment bolt 86 in reverse, the clamping component 82 may be lowered by gravity. A third adjustment bolt 87 is provided on the mounting base 81 for adjusting the mobile frame 85 for moving forward and backward. The third adjustment bolt 87 is thread connected to the mobile frame 85. By rotating the third adjustment bolt 87, the mobile frame 85 may move forward and backward relative to the mounting base 81.

Optionally, the living object installation device 8 may further include a shading mechanism for covering eyes of the living object. The shading mechanism includes a shading cover 83 and a rotating component 84 that drives the shading cover 83 to rotate. When the wide field search is performed and the mouse is imaged, the rotating component 84 may be operated so that the shading cover 83 may cover the eyes of the mouse to protect them from light damage.

The living object installation device 8 may further include a water dispenser (not shown in the figure) provided on the mounting base 81, and the water dispenser is provided for providing water for the mouse on the treadmill 88, which may help distract the attention of the mouse.

The living object installation device 8 may further include a collection tray 89 located below the mounting base 81 for collecting excrement of the mouse.

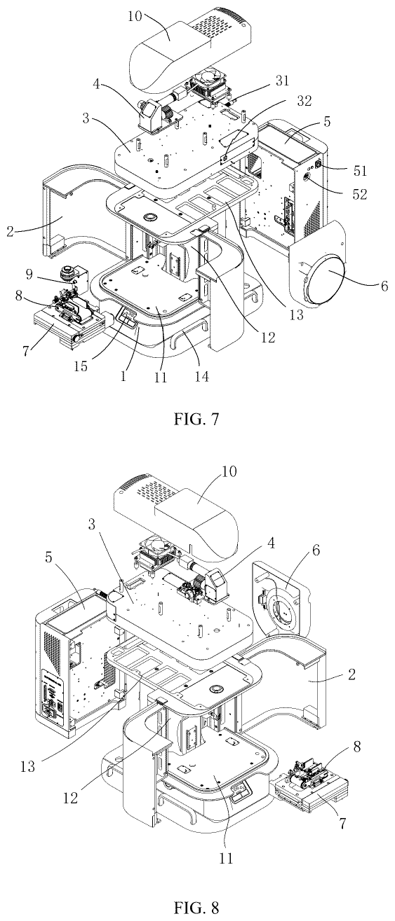

In an embodiment, as shown in FIGS. 7 and 9, the multiphoton microscope main unit may further include a view search adapter 9 installed on the installation body 1. The view search adapter 9 includes a probe installation component 91 and a switching mechanism. The probe installation component 91 is used for detachably installing the microscope probe 400, and the switching mechanism is configured to switch the probe installation component 91 to a first position and a second position.

When the probe installation component 91 is located at the first position, the microscope probe 400 installed on the probe installation component 91 is configured to avoid an optical path between the wide field search module 4 and the living object; when the probe installation component 91 is located at the second position, the microscope probe 400 is aligned with the optical path of the wide field search module 4.

The switching mechanism may be configured to be manually pushed and pulled to switch the probe installation component 91 between two positions. Specifically, a grip portion (not shown in the figures) convenient for grip may be provided on the switching mechanism. By pushing the grip portion, the probe installation component 91 may be moved to the first position; and by pulling the grip portion in the opposite direction, the probe installation component 91 may be moved to the second position.

Furthermore, an objective 43 may be provided on the view search adapter 9. When the view search adapter 9 is installed on the installation body 1, the objective lens 43 is aligned with the optical path of the wide field search module 4, and the microscope probe 400 installed on the probe installation component 91 needs to be aligned with the optical path of the wide field search module 4 when the probe installation component 91 is located at the second position. When the wide field search module 4 is used for wide field imaging, the probe installation component 91 is switched to the first position through the switching mechanism. After a target region on the living object is found, the probe installation component 91 is switched to the second position. Then, the microscope probe 400 installed on the probe installation component 91 is removed and fixed at the position (which can be fixed by adhesive) corresponding to the target region on the probe mounting component 80 of the living object.

After the microscope probe 400 is installed on the probe mounting component 80, the living object (such as a mouse) may be removed from the living object installation device 8 and released to move freely, so that neuronal activity in a freely moving mouse can be observed through the microscope probe 400.

In an embodiment, the multiphoton microscope main unit 100 may further include a shading door 2 installed on the installation body 1, which can be opened and closed. When the shading door 2 is in a closed state, a closed space may be formed between the installation body 1 and the shading door 2. The move module 7 is located within the closed space, and the wide field search module 4 is configured to perform wide field search on the living object located on the move module 7 in the closed space.

The shading door 2 may ensure that the living object to be located in a dark room when the living object is imaged by the wide field search module 4, thereby achieving a high imaging signal-to-noise ratio. Moreover, by providing the shading door 2, there is no need to build a dedicated dark environment (such as providing a large hood or turning off laboratory lighting, and so on).

Optionally, as shown in FIGS. 5 and 6, two shading doors 2 may be provided, adopting an opposite opening manner; that is, the two shading doors 2 may be rotatably installed on the installation body 1, and may be closed when rotating towards each other and opened when rotating away from each other. FIG. 5 shows a state of two shading doors 2 when they are closed, and FIG. 6 shows a state of two shading doors 2 when they are open.

The shading door 2 may be set as one, and it may also be set to open and close through lifting or sliding.

In an embodiment, a specific arrangement of each module of the multiphoton microscope main unit 100 may be referred to FIGS. 7 and 8. The installation body 1 includes a base 11, an installation bracket 12 fixed on the base 11, and a support plate 13 provided above the installation bracket 12. The move module 7 is movably installed on the base 11 and is located on a side of the installation bracket 12. A control box located below the support plate 13 is installed on another side of the installation bracket 12, and the scanning control module and the fluorescence collection module are disposed in the control box 5. The laser coupling module 3 is installed on the support plate 13, and the wide field search module is installed above the move module 7. The shading door 2 is installed on a side, facing the move module 7, of the installation bracket 12, to form a closed space on the side, with the move module 7, of the installation bracket 12. The optical path of the wide field search module 4 located above may enter the closed space to image the living object fixed on the move module 7.

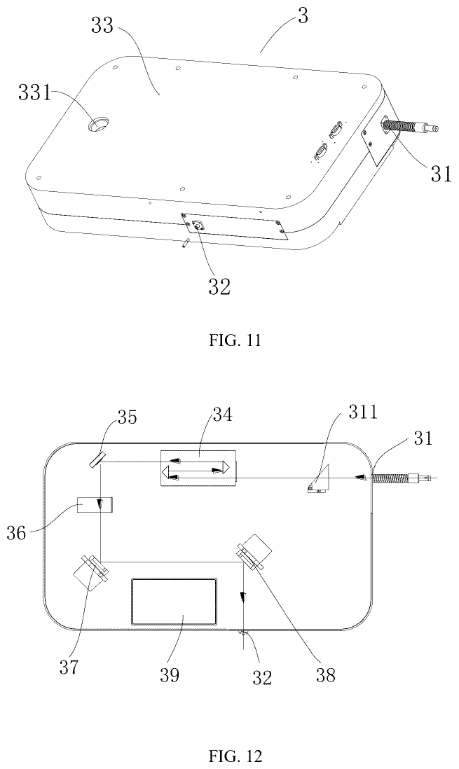

Optionally, as shown in FIG. 11, the wide field search module 4 may be installed on the laser coupling module 3, and the laser coupling module 3 is provided with an optical path through-hole 331 penetrating the laser coupling module 3 up and down. The optical path of the wide field search module 4 is configured to pass down through the optical path through-hole 331 and reach the move module 7. This arrangement may enable the overall structure to be more compact, and make the volume more compact.

Optionally, as shown in FIG. 7, a handle 14 may be provided on the base 11 to facilitate transportation of the multiphoton microscope main unit 100.

Optionally, as shown in FIG. 7, a display screen 15 may further be provided on the base 11, and the display screen 15 is configured to display, for example, parameters and transmission status of the laser, temperature and humidity of the multiphoton microscope main unit, and so on, to facilitate understanding the working status of the device.

In an embodiment, as shown in FIGS. 11 and 12, the laser coupling module 3 includes a coupler shell 33, a dispersion compensation member 34, an acousto-optic modulator 36, and a second beam stabilization device. The dispersion compensation member 34, the acousto-optic modulator 36, and the beam stabilization device are sequentially disposed in the coupler shell 33 along a laser transmission direction. The dispersion compensation member 34 is configured to compensate for negative dispersion caused by laser transmission through the transmission fiber 301. The acousto-optic modulator 36 is configured to adjust intensity of the laser. The second beam stabilization device is configured to adjust the laser transmission direction to correct a deviation between an actual position and an ideal position of a laser beam at a laser output end 32 of the laser coupling module 3. The second beam stabilization device may specifically include a position detector 39.

The position detector 39 is disposed near the laser output end 32 of the laser coupling module 3, and is configured to detect position information of the laser at the laser output end 32. The position detector 39 may be a 4D position detector, which can strictly detect and distinguish a position drift and an angle drift of the beam, and accurately detect a real-time position of the beam. The mirror adjustment mechanism is configured to drive the deflection mirror to adjust the laser transmission direction based on the position information detected by the position detector 39, so that the laser may be stably output from the laser output end 32 to the laser transmission fiber, which is conducive to improving coupling efficiency.

Specifically, firstly, the ideal position of the laser beam is determined at the laser output end 32. The ideal position is a position where the laser may achieve a desired coupling efficiency when being output and coupled to the connected laser transmission fiber 401 at laser output end 32. When the beam is deflected, for example, due to deviation of optical components caused by vibration or temperature changes, or human touch, the position detector 39 detects the position information of the laser at the laser output end 32 in real time and sends it to the control unit. The control unit continuously determines the deviation between the position of the laser beam and the ideal position based on the position information, and controls the mirror adjustment mechanism to adjust the deflection mirror, thereby continuously adjusting the laser reflection direction, so that the laser can be stably transmitted to the laser transmission fiber 401 within a certain range around the ideal position. The control unit may be disposed inside the laser coupler shell 33 or inside the control box 5.

Optionally, the laser coupling module 3 may further be provided with at least one mirror 35 for changing the laser transmission direction. By changing the laser transmission direction, the optical path may be bent, making it easier to arrange various components on the optical path and reducing s volume of the entire laser coupling module.

Specifically, as shown in FIG. 12, the laser enters the laser coupling module 3 from the laser input end 31. Then the dispersion compensation member 34 performs dispersion compensation on the laser and transmits the laser to the mirror 35. The laser is deflected by the mirror 35 by 90 degrees approximately, and transmitted to the acousto-optic modulator 36. The acousto-optic modulator 36 adjusts the intensity of the laser, and transmits the laser to the first deflection mirror 37. The laser is deflected by the first deflection mirror 37 by 90 degrees approximately, and reflected to the second deflection mirror 38. The laser is reflected by the second deflection mirror 38 to the laser output end 32, and coupled into the laser transmission fiber 401 connected to the laser output end 32. Therein, the first deflection mirror 37 and the second deflection mirror 38 are respectively provided with corresponding mirror adjustment mechanisms, which are configured to adjust positions of the first deflection mirror 37 and the second deflection mirror 38 based on the position information detected by the position detector 39 in real time, so that the laser may be stably output to the laser transmission fiber 401.

The laser coupling module 3 may further be provided with a power detector 311 for detecting laser transmission power.

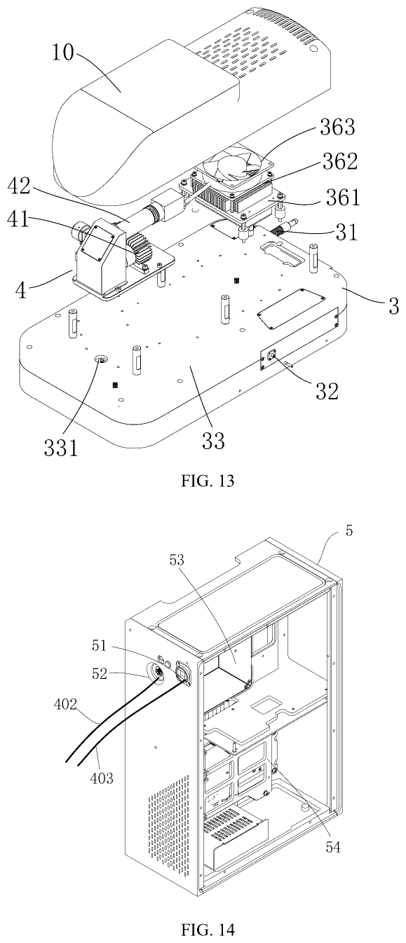

In addition, as shown in FIG. 13, the laser coupling module may further include a driver 361 for driving the acousto-optic modulator 36 and a cooling mechanism for cooling the driver 361. The driver 361 and the cooling mechanism are disposed on an upper surface of the coupler shell 33. The cooling mechanism may include a heat dissipation fin 362 for cooling the driver 361 and a fan 363 for cooling the heat dissipation fin 362.

Due to a high radio frequency power of the driver 361, risk of high-power radio frequency signal interference may be increased by placing the driver 361 inside the laser coupler shell 33. Moreover, due to high heat generated by driver 361, it is easy to cause flat deformation of the precise optical system, increase a temperature inside cavity, and affect device performance. Therefore, the driver 361 is disposed outside the coupler shell 33, and the heat dissipation fin 362 and the fan 363 are added for heat dissipation.

Optionally, referring to FIG. 13, the wide field search module 4 is installed on an upper surface of the coupler shell 33, and the laser coupling module 3 is provided with an optical path through-hole 331 penetrating the laser coupling module 3 up and down. The optical path of the wide field search module 4 is configured to pass down through the optical path through-hole 331. The wide field search module 4 may include a fluorescent source 41 and a camera 42, and the optical path of the camera 42 may pass down through the optical path through-hole 331 to reach the living object disposed on the move module 7, and perform wide field imaging on the living object.

The multiphoton microscope main unit may further include a cover 10 for covering the wide field search module 4, the driver 361, and the cooling mechanism. The cover 10 not only provides protection but also facilitates aesthetics.

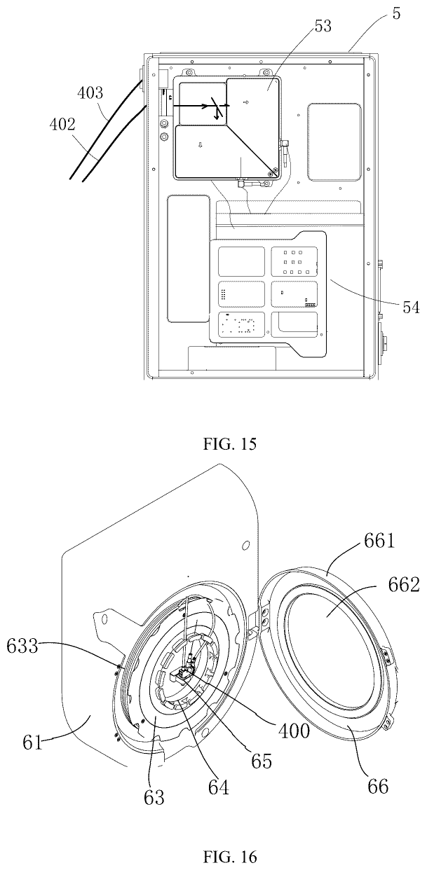

In an embodiment, as shown in FIGS. 14 and 15, the multiphoton microscope main unit may further include a control box 5 installed on the installation body 1, and the fluorescence collection module and the scanning control module are both disposed in the control box 5.

Therein, the fluorescence collection module 53 may include a photomultiplier tube (PMT), and the signal collected by the fluorescence collection fiber 402 is transmitted to the photomultiplier tube.

Optionally, the fluorescence collection module 53 may include a spectroscope and at least two beam-split collection modules. Each beam-split collection module may include a photomultiplier tube. The fluorescence signal collected by the fluorescence collection fiber 402 from the microscope probe 400 is split into at least two fluorescence signals by the spectroscope and collected by the at least two beam-split collection modules.

The control box 5 may further be provided with a signal processing module, and the signal processing module is configured to process the signal output from the fluorescence collection module 53 and transmit the processed signal to the computer for display. For example, the fluorescence signal collected by the fluorescence collection module 53 is converted into an electrical signal and amplified. Then the signal is collected and reassembled through high-speed AD acquisition, and then transmitted to the computer for display.

The fluorescence collection module and the signal processing module are both provided in the control box 5, thereby shortening a transmission distance of the signal collected by the fluorescence collection module to the signal processing module, reducing possibility of interference, and improving reliability of signal transmission

Optionally, the control box 5 may be provided with a first port 51 connected with the fluorescence collection fiber 402 and a second port 52 connected with the control cable 403, and the first port 51 and the second port 52 are located on a same side of the control box 5 and at an upper position of the control box 5.

The laser coupling module 3 is located above the control box 5, and the laser output end 32, configured to be connected with the laser transmission fiber 401, of the laser coupling module 3 is located on a same side as the first port 51 and the second port 52 of the control box 5.

By disposing the laser coupling module 3 above the control box 5, the first port 51 and the second port 52 of the control box 5 are located at the upper position of the control box 5, and the laser output end 32 of the laser coupling module 3 is on the same side as the first port 51 and the second port 52 of the control box 5, which makes the laser transmission fiber 401, the fluorescence collection fiber 402, and the control cable 403 close to each other, so that the wiring may be neat and beautiful, and the cables may further be converged into a total cable. For example, the cables may be wrapped into a total cable with wire skin after aggregation, and may be conveniently stored through a storage device 6 (a specific description of the storage of the cable and the microscope probe through the storage device will be given below)

In addition, output ends of the laser transmission fiber 401, the fluorescence collection fiber 402, and the control cable 403 are disposed at the upper position of the control box 5 to facilitate adapting to more behavioral devices and reduce length of cables. For example, when placing a mouse with the microscope probe 400 and with free movement in a living object behavior box, the arrangement of cables may facilitate downward extension of the microscope probe 400 into the living object behavior box.

Furthermore, as shown in FIGS. 14 and 15, the control box 5 is provided with a main control circuit board 54 and the fluorescence collection module 53. The fluorescence collection module 53 is located above the main control circuit board 54. The main control circuit board 54 includes the scanning control module, and may also include a control driving circuit for controlling the laser coupling module 3 (for example, controlling the acousto-optic modulator and the second beam stabilization device of the laser coupling module 3), the wide field search module 4, an indicator light, a light sensor, a temperature and humidity sensor, and so on.

In an embodiment, the multiphoton microscope main unit may further include the storage device 6, and the storage device 6 is disposed on a side, where the first port 51 and the second port 52 are arranged, of the control box 5. Since the laser transmission fiber 401, the fluorescence collection fiber 402, and the control cable 403 are all located on this side, by installing the storage device 6 on this side, the storage of the microscope probe 400 and cables connected to the microscope probe 400, including the laser transmission fiber 401, the fluorescence collection fiber 402, and the control cable 403, may be facilitated. For the convenience of storage, the cables may be wrapped into a total cable with wire skin after aggregation.

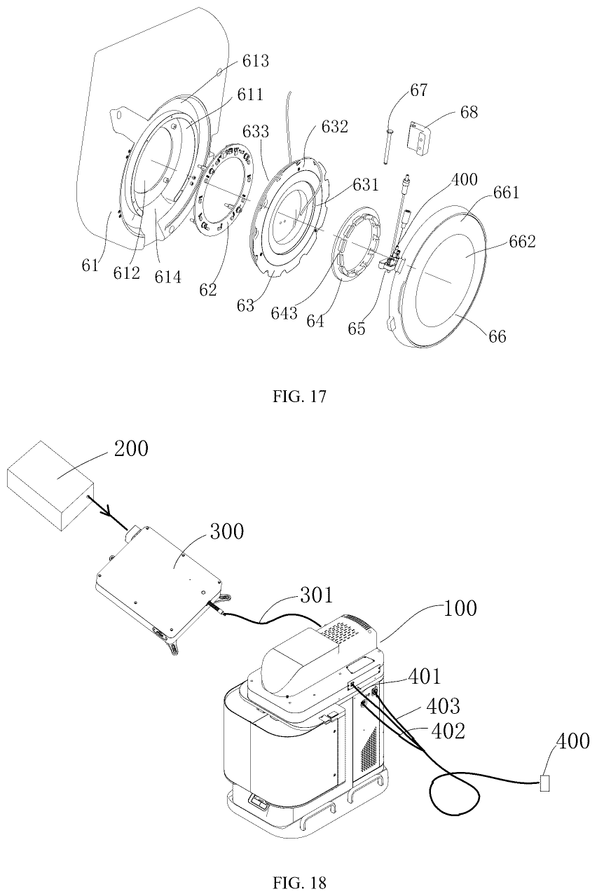

As shown in FIGS. 16 and 17, the storage device 6 may include: a storage body and a winding drum 633 provided on the storage body, and an annular space is formed around the winding drum 633 for accommodating a cable. A probe bracket 65 is fixed on the storage body. When the cable is wound on the winding drum 633, the microscope probe 400 may be installed on the probe bracket 65.

FIG. 16 shows a state where the cable is wound on the winding drum 633 and the microscope probe 400 is installed on the probe bracket 65. By using the storage device 6 for storage, the cables and probes will not be easily damaged by touching or pressing. Entanglement and knotting of the cable caused by random placement may further be avoided, as well as damage of the cable caused by arbitrary bending. Moreover, by using the storage device 6 to store the cable and the probe, the multiphoton microscope main unit may be more neat and beautiful, which is conducive to improving visual effects.

Specifically, the storage body may include: a storage box 61 and a wire blocking plate 63 fixed on the storage box 61. The probe bracket 65 is fixed on an outer side, away from the storage box 61, of the wire blocking plate 63. The winding drum 633 is disposed on the storage box 61 or the wire blocking plate 63, and the storage box 61 and the wire blocking plate 63 are configured to stop the cable wound on the winding drum 633 from both ends of the winding drum 633.

In the embodiment shown in FIG. 17, the wire blocking plate 63 includes the winding drum 633 and a wire blocking ring 632 radially protruding from the winding drum 633. When the winding drum 633 is fixed on the storage box 61, an annular space around the winding drum 633 is formed between the wire blocking ring 632 and the storage box 61. Of course, the winding drum 633 may also be directly formed on the storage box 61. The wire blocking plate 63 is fixed at an end, away from the storage box 61, of the winding drum 633, and is provided with the wire blocking ring 632 that radially protrudes from the winding drum 633.

The structure of the probe bracket 65 may be various, as long as the microscope probe 400 can be installed. For example, the probe bracket 65 may be set as a clamping structure that can hold the probe, or a socket may be set on the probe bracket 65 to insert the microscope probe 400 into the socket.

Optionally, a plurality of limit notches may be provided with intervals along the circumference on the outer circumference of the wire blocking plate 63 (that is, on the wire blocking ring 632), and the cable extends from the winding drum 633 to the outer side of the wire blocking plate 63 so that when the probe is installed on the probe bracket 65, the cable is limited by one of the plurality of limit notches.

Optionally, a clamp ring 64 may be provided on the outer side of the wire blocking plate 63 facing away from the winding drum 633, and a plurality of slots 643 are provided around the probe bracket 65 on the clamp ring 64. A plurality of protrusions may be provided along the circumference on the clamp ring 64, and adjacent protrusions form the slot 643 between them. When the cable is extended to the outer side of the wire blocking plate 63 to allow the probe to be installed on the probe bracket 65, the cable may be stuck in one of the plurality of slots 643. Thus, the cable may be prevented from loosening from the winding drum 633 and the probe may be prevented from being detached from the probe bracket 65 due to cable swinging or loosening. prevents the probe from detaching from the probe bracket due to cable swinging or loosening. Therein, the clamp ring 64 may be made of flexible materials, such as rubber, since the flexible material has elasticity, making it easy for the cable to get in and out of the slot.

In an embodiment, a through-hole 612 is formed on a side, used for sticking to the control box 5, of the storage box 61. The through-hole 612 is connected to the annular space containing the cable, and an end, with the microscope probe 400, of the cable enters the storage box 61 from the through-hole 612 and may extend into the annular space and wind around the winding drum 633.

Specifically, the storage box 61 is provided with a protruding portion 611 that protruding towards the winding drum 633 around the through-hole 612, and an annular groove 613 is formed on the radial outer side, away from the through-hole 612, of the protruding portion 611. The winding drum 633 is disposed on the wire blocking plate 63, which is fixed on the protruding portion 611. The annular groove 613 forms an annular space for winding the cable between the storage box 61 and the wire blocking plate 63. The protruding portion 611 may be set as an annular structure or an arc-shaped structure with a notch. To install the winding drum 633, an external thread may be provided on the outer surface of the protruding portion 611, and an internal thread may be provided on the inner surface of the winding drum 633. The winding drum 633 may be connected to the protruding portion 611 of the storage box 61 through a threaded connection manner.

A through groove 614 is provided on the protruding portion 611 that radially passes through the protruding portion 611, and the end, with the microscope probe 400, of the cable may extend outward from the through groove 614 into the annular space after entering the storage box 61 through the through-hole 612. The through groove 614 may be a notch formed on the protruding portion 611 as shown in FIG. 17, or a through-hole disposed on the wall of the protruding portion 611. When the winding drum 633 is fixed on the protruding portion 611, the through groove 614 is roughly located at an end of the winding drum 633, and the cable may extend from the through groove 614 to the annular space and be wound on the winding drum 633.

In an embodiment, the storage device may further include an annular indicator light 62, which is installed on the storage body and is arranged around the center of the winding drum 633. The annular indicator light 62 is configured to provide internal illumination for the storage device 6, or to indicate the working status inside the multiphoton microscope main unit. For example, the annular indicator light 62 may be configured to use different colors to indicate that the device is in working status, non-working status, failure, or device abnormality. If the laser is detected entering the laser coupling module 3 or the laser device is detected emitting laser, a controller may control the annular indicator light 62 to display green, which indicates that the device is in working state; if the device is detected abnormality, such as abnormal laser power or other abnormal states, the annular indicator light 62 may be controlled to display red as a warning; if the device is in non-working status, the annular indicator light 62 may be controlled to display yellow for internal lighting.

The wire blocking plate 63 includes a transparent cover 631, and the annular indicator light 62 is disposed between the storage box 61 and the wire blocking plate 63. Corresponding to the transparent cover 631, the light from the annular indicator light 62 may be seen through the transparent cover 631. The wire blocking ring 632 of the wire blocking plate 63 is disposed on an outer ring of the transparent cover 631.

In addition, the storage device 6 may further include a protection cover 66 covering the outer side of the storage body, which is rotatably installed on the storage body through a shaft 67 and a hinge 68. The protection cover 66 may be rotated to an open state and closed state. To keep the protection cover 66 closed, a magnet may be provided between the protection cover 66 and the storage body.

The protection cover 66 may include an annular cover body 661 and a transparent observation window 622 disposed at the center of the annular cover body 661 to facilitate observation of the internal situation of the storage device, and to facilitate observation of the device status indicated by the annular indicator light 62.

When in use, after rotating the protection cover 66 to open, removing the microscope probe 400 from the probe bracket 65, and unwinding the cable from the winding drum 633, the probe may be installed on a living object for use.

According to another aspect of the present disclosure, an optical system is provided. As shown in FIGS. 18 and 19, the multiphoton microscope system includes a laser device 200, a microscope probe 400, and a multiphoton microscope main unit 100 as described above, where the laser device 200 is configured to transmit laser to a laser coupling module 3, and an output end of the laser coupling module 3 is connected to a microscope probe 400 through a laser transmission fiber 401, a fluorescence collection module is connected to the microscope probe 400 through a fluorescence collection fiber 402, and a scanning control module is connected to the microscope probe 400 through a control cable 403.

In an embodiment, as shown in FIG. 18, the optical system may further include a laser adapter 300. Firstly, the laser device 200 emits the laser to the laser adapter 300, the laser adapter 300 adjust and adapt the laser and then transmits the laser to the multiphoton microscope main unit 100 through the transmission fiber 301.

By providing the laser adapter 300 between the laser device 200 and the multiphoton microscope main unit 100, laser emitted by laser devices 200 with different parameters may be adapted to an apparatus connected therebehind through the adjustment of the laser adapter 300. Moreover, as the laser adapter 300 is connected to the multiphoton microscope main unit 100 through a fiber optic connection, the multiphoton microscope main unit 100 may move freely. Therefore, the multiphoton microscope main unit 100 may be placed in different positions or even cross platforms as needed, making it more flexible to use.

The laser adapter 300 may specifically include a shell, and a beam transformation device and a beam stabilization device provided in the shell, The beam transformation device is configured to perform transformation to a laser beam entering the shell, where the transformation of a beam refers to amplification, reduction, and zooming of a beam through transformation characteristics of optical components, enabling the laser to match with an apparatus connected therebehind and achieve a best performance of the device. The beam stabilization device is disposed downstream of the beam transformation device in a transmission direction of laser, and is configured to adjust the laser transmission direction to correct a deviation between an actual position and an ideal position of the laser beam at the laser output port. And the configuration of the beam stabilization device is similar to that of the second beam transformation device in the laser coupling module 3. By adjusting deflection direction of the laser when detecting a deviation of the laser beam through the beam stabilization device, stability of laser output may be ensured, thereby ensuring coupling efficiency of the laser output.

The description provided above are merely preferred embodiments of the present disclosure and are not intended to limit the present disclosure. Any modifications, equivalent substitutions, and so on made within the spirit and principles of the present disclosure shall be included within the protection scope of the present disclosure.

1. A laser adapter, comprising: a shell, a beam transformation device and a beam stabilization device arranged in the shell, wherein
the shell is provided with a laser input port and a laser output port;
the beam transformation device is configured to transform a laser beam entering the shell; and
the beam stabilization device is disposed downstream of the beam transformation device in a laser transmission direction, and is configured to adjust the laser transmission direction to correct a deviation between an actual position and an ideal position of the laser beam at the laser output port.

2. The laser adapter according to claim 1, wherein the beam stabilization device comprises a position detector, at least one deflection mirror, and a mirror adjustment mechanism connected to a respective deflection mirror;
the position detector is disposed near the laser output port, and is configured to detect position information of the laser beam at the laser output port; and
the mirror adjustment mechanism is configured to drive the at least one deflection mirror to rotate to adjust the laser transmission direction based on the position information detected by the position detector.

3. The laser adapter according to claim 2, further comprising a control unit, wherein the control unit is configured to receive the position information detected by the position detector and control the mirror adjustment mechanism based on the position information.

4. The laser adapter according to claim 2, further comprising at least one fixed mirror, configured to change the laser transmission direction, wherein the fixed mirror is disposed upstream of the beam transformation device in the laser transmission direction.

5. The laser adapter according to claim 4, wherein the at least one fixed mirror comprises a first fixed mirror and a second fixed mirror, and the at least one deflection mirror comprises a first deflection mirror and a second deflection mirror; and
the first fixed mirror is configured to reflect the laser beam to the second fixed mirror, the second fixed mirror is configured to reflect the laser beam to the beam transformation device; the first deflection mirror is configured to reflect the laser beam emitted from the beam transformation device to the second deflection mirror; and the second deflection mirror is configured to reflect the laser beam to the laser output port.

6. The laser adapter according to claim 1, wherein the shell is provided with at least one laser power meter, configured to detect power of the laser beam that enters the laser adapter.

7. The laser adapter according to claim 6, wherein the at least one laser power meter comprises a first laser power meter and a second laser power meter, the first laser power meter is configured to detect power of the laser beam at the laser input port and disposed near the laser input port, and the second laser power meter is configured to detect power of the laser beam at the laser output port and disposed near the laser output port.

8-9. (canceled)

10. An optical system, comprising a laser device, a main unit of application apparatus, and the laser adapter according to claim 1, wherein
the laser device is configured to emit the laser beam to the laser adapter;
the laser adapter is configured to receive the laser beam emitted by the laser device, adjust and adapt the laser beam, and transmit the laser beam adjusted and adapted to the main unit of application apparatus; and
the main unit of application apparatus is configured to transmit the laser beam to a microscope probe, and control the microscope probe to perform laser scanning on a living object to generate a fluorescence signal used for imaging.

11. The optical system according to claim 10, further comprising a transmission fiber connected between the laser adapter and the main unit of application apparatus, wherein the laser adapter is configured to transmit the laser beam adjusted and adapted to the main unit of application apparatus through the transmission fiber;
the main unit of application apparatus comprises a laser coupling module, a laser input end of the laser coupling module is connected to the transmission fiber, and a laser output end of the laser coupling module is connected to the microscope probe through a laser transmission fiber; and
the laser coupling module is configured to adjust the laser beam received from the transmission fiber, and transmit the laser beam to the microscope probe through the laser transmission fiber.

12. (canceled)

13. The optical system according to claim 11, wherein the laser coupling module comprises a power detector configured to detect laser power; and
the second laser power meter is located near the laser output port of the laser adapter, and the power detector is located near the laser input end of the laser coupling module.

14. (canceled)

15. The optical system according to claim 10, wherein the main unit of application apparatus comprises a multiphoton microscope main unit connected to the microscope probe, the multiphoton microscope main unit comprises an installation body, and a wide field search module, a laser coupling module, a fluorescence collection module, and a scanning control module are integrated on the installation body;
the wide field search module is configured to perform wide field imaging on the living object to search a target region on the living object, which is used for installing the microscope probe;
the laser coupling module is configured to receive the laser beam, and adjust the laser beam to couple the laser beam into a laser transmission fiber, and the laser transmission fiber is configured to connect the laser coupling module to the microscope probe;
the scanning control module, connected to the microscope probe through a control cable, is configured to control the microscope probe to perform laser scanning to generate the fluorescence signal; and
the fluorescence collection module, connected to the microscope probe through a fluorescence collection fiber, is configured to collect the fluorescence signal output by the microscope probe.

16. The optical system according to claim 15, wherein the multiphoton microscope main unit further comprises a view field search adapter installed on the installation body;
the view field search adapter comprises a probe installation component and a switching mechanism, the microscope probe is detachably installed on the probe installation component, and the switching mechanism is configured to switch the probe installation component to a first position or a second position; and
when the probe installation component is switched to the first position, the microscope probe installed on the probe installation component is configured to avoid an optical path between the wide field search module and the living body; and when the probe installation component is switched to the second position, the microscope probe is aligned with an optical path of the wide field search module.

17. The optical system according to claim 15, wherein the multiphoton microscope main unit further comprises a move module installed on the installation body, the move module is configured to load the living body and drive the living body to move in a plurality of directions, and the wide field search module is configured to perform view field search on the living body fixed on the move module.

18-20. (canceled)

21. The optical system according to claim 15, wherein the laser coupling module comprises a coupler shell, a dispersion compensation member, an acousto-optic modulator, and a second beam stabilization device, the dispersion compensation member, the acousto-optic modulator, and the second beam stabilization device are sequentially disposed along a laser transmission direction in the coupler shell;
the dispersion compensation member is configured to compensate for negative dispersion caused by laser transmission through the transmission fiber;
the acousto-optic modulator is configured to adjust intensity of the laser beam; and
the second beam stabilization device is configured to adjust the laser transmission direction to correct a deviation between an actual position and an ideal position of the laser beam at a laser output end of the laser coupling module.

22-23. (canceled)

24. The optical system according to claim 15, wherein the multiphoton microscope main unit further comprises a control box disposed on the installation body, and the fluorescence collection module and the scanning control module are arranged in the control box.

25. The optical system according to claim 24, wherein the control box is provided with a first port connected to the fluorescence collection fiber and a second port connected to the control cable, and the first port and the second port are located on a same side of the control box; and
the laser coupling module is located above the control box, and a laser output end, used for connected to the laser transmission fiber, of the laser coupling module is located on a same side as the first port and the second port of the control box.

26-27. (canceled)

28. A multiphoton microscope main unit, configured to be connected with a microscope probe, comprising an installation body, wherein a wide field search module, a laser coupling module, a fluorescence collection module, and a scanning control module are integrated on the installation body,
the wide field search module is configured to perform wide field imaging on the living object to search a target region on the living object for installing the microscope probe;
the laser coupling module is configured to receive the laser beam, and adjust the laser beam to couple the laser beam into a laser transmission fiber, and the laser transmission fiber is configured to connect the laser coupling module to the microscope probe;
the scanning control module, connected to the microscope probe through a control cable, is configured to control the microscope probe to perform laser scanning to generate the fluorescence signal; and
the fluorescence collection module, connected to the microscope probe through a fluorescence collection fiber, is configured to collect the fluorescence signal output by the microscope probe.

29. The multiphoton microscope main unit according to claim 28, wherein the multiphoton microscope main unit further comprises a view field search adapter installed on the installation body;
the view field search adapter comprises a probe installation component and a switching mechanism, the microscope probe is detachably installed on the probe installation component, and the switching mechanism is configured to switch the probe installation component to a first position or a second position; and
when the probe installation component is switched to the first position, the microscope probe installed on the probe installation component is configured to avoid an optical path between the wide field search module and the living body; and when the probe installation component is switched to the second position, the microscope probe is aligned with an optical path of the wide field search module.

30-39. (canceled)

40. A multiphoton microscope system, comprising: a laser device, a microscope probe, and the multiphoton microscope main unit according to claim 28, to wherein
the laser device is configured to transmit laser to the laser coupling module, and the output end of the laser coupling module is connected to the microscope probe through the laser transmission fiber, the fluorescence collection module is connected to the microscope probe through the fluorescence collection fiber, and the scanning control module is connected to the microscope probe through the control cable.

41. An optical imaging system, comprising: a laser device, a laser adapter, and a microscope host, wherein
the laser device is configured to emit laser to the laser adapter;
the laser adapter is configured to receive the laser emitted by the laser device, adjust and adapt the laser, and transmit the laser adjusted and adapted to the microscope host; and
the microscope host is configured to transmit the laser to a microscope probe, and control the microscope probe to perform laser scanning on a living object to generate a fluorescence signal used for imaging.
